(19) United States
(12) Patent Application Publication
(10) Pub. No.: US 2013/0339454 A1
(43) Pub. Date: Dec. 19, 2013

(54) SYSTEMS AND METHODS FOR COMMUNICATING BETWEEN MULTIPLE ACCESS DEVICES

(71) Applicants: MICHAEL WALKER, Blisworth (GB); Daniel Meech, Newport Pangell (GB); Nicholas Hencher, London (GB); Peter Pircher, Baar (GB); Daniel Bennett, Rosemount (GB)

(72) Inventors: MICHAEL WALKER, Blisworth (GB); Daniel Meech, Newport Pangell (GB); Nicholas Hencher, London (GB); Peter Pircher, Baar (GB); Daniel Bennett, Rosemount (GB)

(21) Appl. No.: 13/524,414

(22) Filed: Jun. 15, 2012

(51) Int. Cl. H04L 12/58

(52) U.S. Cl. CPC H04L 51/04
USPC 709/206

(57) ABSTRACT

A method includes verifying, via an application chat server, an association between a first access device and a second access device, wherein the first access device and the second access device associated with a first statement of task capability and a second statement of task capability, respectively. The method further includes analyzing, based upon one or more of the first and second statements of task capability, a task command to determine that the second access device is capable of executing at least one task. The method further includes generating, in response to the determining, an execution command, wherein the execution command associated with the at least task and transmitting an execution signal, wherein the execution signal associated with the execution command.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2012 Thomson Reuters.

### TECHNICAL FIELD

Various embodiments of the present invention concern systems and methods for communicating between multiple access devices.

### BACKGROUND

Mobile access devices (e.g., a smartphone, a tablet) are being used by millions of people every day. The release of smartphones and tablets is rapidly changing how people want to interact with information and software solutions. To date, companies have concentrated on manipulating an existing product to allow for a smaller screen experience. This may be beneficial when an individual is mobile while utilizing a mobile access device. However, an increasing trend has the individual using a mobile access device in the office or other fixed location. Therefore, there are challenges that this mobile shift brings. One challenge is how to securely access data on a mobile access device. Another challenge is how to provide a seamless user experience across multiple access device screens. Each challenge is discussed herein.

The challenge of securely assessing data on a mobile access device, particularly when the data is behind a firewall, has been ongoing. Access from mobile access devices to data and services behind a company firewall can be a frustrating experience. An enterprise server must either open the firewall to allow inbound connections and/or deploy a virtual private network (VPN). An enterprise server is a server or set of servers containing programs that collectively serve the needs of an enterprise (e.g., an entire company) rather than a single user, department, or specialized application. Both approaches (opening firewall and VPNs) have their downsides. In the first approach, the firewall, used for Microsoft® Exchange, being opened allows for potentially unsecured email traffic when set up incorrectly (e.g., poor filters for spam and viruses). For example, a virus could affect not only an individual's laptop but potentially a host of servers behind the firewall. In the second approach, VPNs are poorly understood by end users. VPNs require investment and, certainly today, are not a very seamless experience from the access device. Compounding that there are a myriad of competing standards, some of which are supported by the access device's operating system (OS), while others require helper applications like Junos on iOS. Most require additional software and all consume central processing unit (CPU) resources that could be spent on the user experience.

The challenge of how to provide a seamless user experience across multiple access devices is a function of the increased usability and importance to an individual's workflow on mobile devices. Previously, a laptop was considered the sole tool for mobile knowledge. As long as software and solutions worked successfully on Microsoft® Windows®, a company had a successful product. Since millions of individuals have smartphones and/or tablets, workflow is no longer limited to a single screen or access device. For example, an individual may start writing a document on one access device, email the document to himself and then continue writing the document on another access device. However, seamless access to work product is just the beginning. An assumption is that the individual only works on one device at a time. For example, a lawyer starts writing a brief on the work desktop, saves to a cloud, and reviews the brief on a tablet during his commute. Increasingly though, these access device screens are being used concurrently. For example, the tablet is used alongside the desktop.

Accordingly, the inventors have realized improvements to communicating between multiple access devices.

### SUMMARY

The improvement allows multiple access devices to be registered to an application chat server. An application chat server is a server or a set of servers that is capable of 1) receiving communications from an access device (e.g., a smartphone, a tablet, a laptop or a desktop computer), 2) analyzing the communication and determining which access device may capable of executing a task (e.g., providing a word processor in which to write a document) and 3) transmitting a signal associated with another communication to the chosen access device. In some embodiments, the improvement permits web servers associated with web based applications to be registered to the application chat server. A web server may be an individual server or a set of servers that transmit content that can be accessed through the Internet. For example, WestlawNext® is an exemplary web based application that assists users in conducting online legal research. There are designated web servers that assist WestlawNext® in transmitting content to subscription-based users and receiving user queries and/or information. The application chat server is then capable of receiving a communication from a given web server, analyzing the communication and determining which web based application may be capable, via the corresponding web server, of executing the task and transmitting a signal associated with another communication to the chosen web server and corresponding web based application.

One advantage of the improvement is to connect the access devices and/or web based application to the application chat server by registering and/or verifying that the given access devices are part of the same account and/or have proper permission. An account may be for an individual, a group and/or a company. Once that secure connection is verified, the communications between the access devices may be transmitted to each other via the application chat server. In additional examples, an enterprise server may be introduced. The enterprise server provides an extra layer of security for access devices that communicate with the enterprise server, particularly when the enterprise server is behind a firewall.

Another advantage is to have the application chat server analyze the tasks that are sent by a first access device to determine which access device is capable of executing the task. This allows for an increased usability and importance to an individual's workflow on mobile access device. If an individual initiates a request to execute a task on a first access device, the application chat server receives a task command associated with the task, and using the information about the account and the access devices associated with the account, determines which access devices is capable of executing the task. This may be particularly helpful in concurrent usage of access devices. For example, if an individual is reading an electronic book (eBook) on a tablet but wants to initiate a search without leaving the eBook, the application chat server takes the task command of searching and determines what other access device, for example, a laptop, might be capable of executing the search while the individual continues to read the eBook.

Additional advantages and/or features of the present invention will be set forth in part in the description. It is to be understood that both the foregoing general description and the following detailed description of the present invention are exemplary and explanatory and are intended to provide further explanation of the present invention as claimed.

### BRIEF DESCRIPTION OF THE DRAWINGS

FIG. 1 is an exemplary system 100 which corresponds to one or more embodiments of the invention.

FIG. 1A is a more detailed view of a sub-system 100A between the application chat server 120 and laptop 130d of FIG. 1 which corresponds to one or more embodiments of the invention.

FIG. 2 is an exemplary device database 110 which corresponds to one or more embodiments of the invention.

FIG. 3 is an exemplary method 300 which corresponds to one or more embodiments of the invention.

FIG. 3A is a continuation of exemplary method 300 which corresponds to one or more embodiments of the invention.

FIG. 4 is an exemplary system 400 which corresponds to one or more embodiments of the invention.

FIG. 5 is an exemplary system 500 which corresponds to one or more embodiments of the invention.

FIG. 6 is an exemplary system 600 which corresponds to one or more embodiments of the invention.

FIG. 7 is an exemplary method 700 which corresponds to one or more embodiments of the invention.

FIG. 7A is an exemplary method 700A which corresponds to one or more embodiments of the invention.

FIG. 8 is an exemplary interface 800 which corresponds to one or more embodiments of the invention.

FIG. 9 is an exemplary system 900 which corresponds to one or more embodiments of the invention.

### DETAILED DESCRIPTION OF THE EXEMPLARY EMBODIMENT(S)

The description includes many terms with meanings derived from their usage in the art or from their use within the context of the description. However, as a further aid, the following examples are presented. The term “application” refers to a computer program that assists a user perform certain tasks within an access device (e.g., a laptop). There are at least two types of applications discussed herein—device applications and web based applications. A device application is a computer program that has been installed within an access device. Examples of device applications include word processing applications, spreadsheet applications, email applications, music applications, mobile applications and the like. A mobile application is a specific device application that resides within a mobile access device (e.g., a tablet). A web based application is an application that is accessed over a network such as the internet or an intranet. An exemplary web based application may be a computer software application that is coded in a browser-supported language (such as JavaScript®, combined with a browser-rendered markup language like HyperText Markup Language (HTML)) and reliant on a browser (e.g., Microsoft® Internet Explorer®, Mozilla® Firefox, Google® Chrome) to render the web based application executable. Exemplary web based applications may include Facebook®, e*Trade®, WestlawNext®, and the like. Some web based applications may be subscription-based while others only require a username and password for successful access. Within the specification, the phrase web based application may refer to a generic web based application or a named web based application. It will be apparent which web based application is being used given the context.

### Exemplary System 100

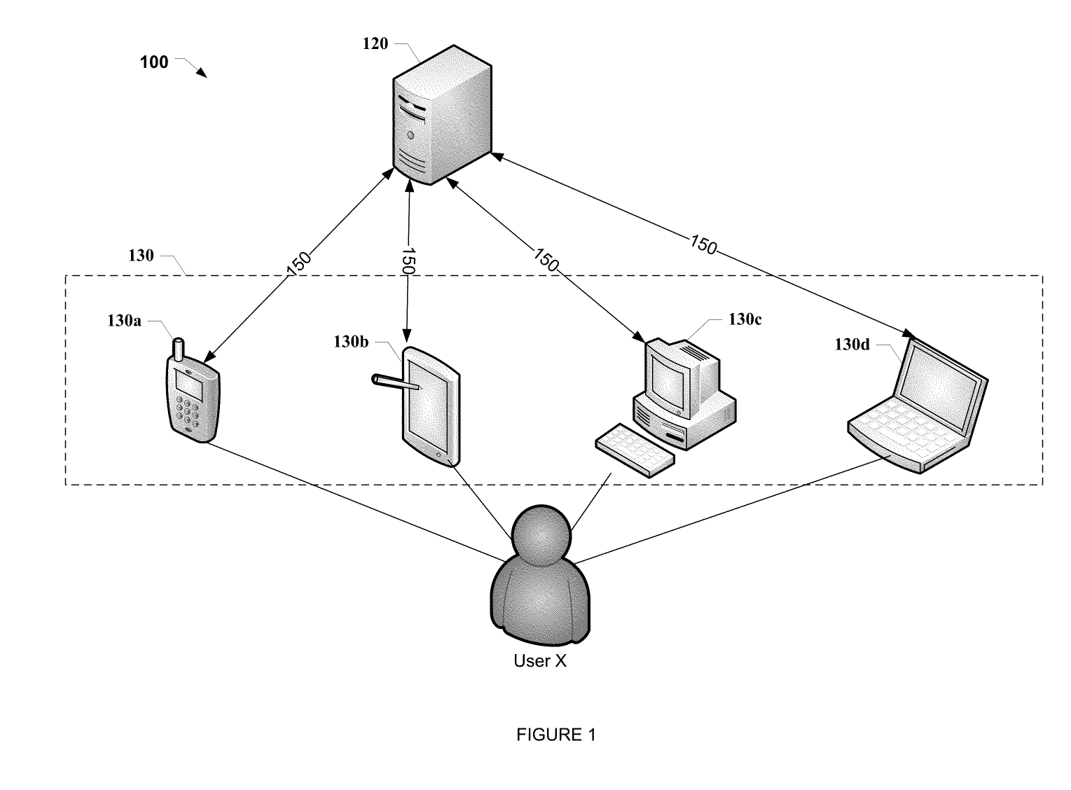

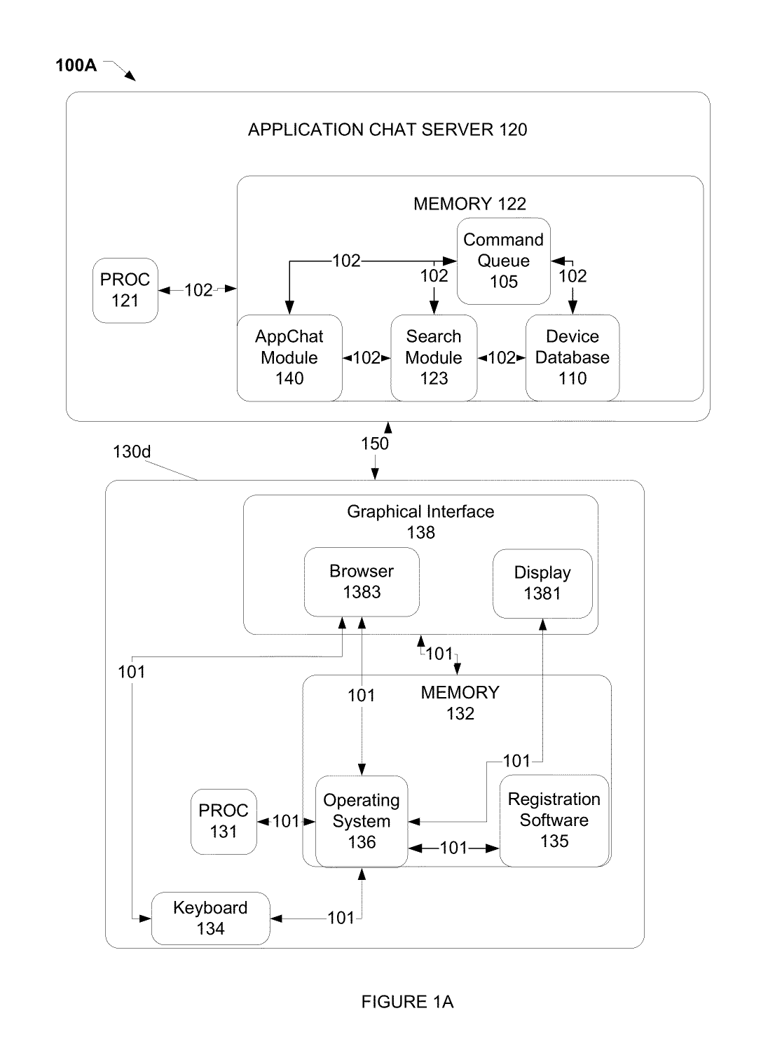

FIGS. 1 and 1A show an exemplary system 100 and an exemplary sub-system 100A, respectively, which may be adapted to incorporate the capabilities, functions, methods, and interfaces of the present invention.

Exemplary system 100 includes an application chat server 120 and a grouping of access devices 130. The application chat server 120 is generally representative of one or more servers for serving data in the form of a webpage or other markup language with associated applets, ActiveX controls, and/or other related software and data structures. The application chat server 120 is capable of 1) receiving communications from an access device (e.g., a smartphone 130a, a tablet 130b, a desktop computer 130c or a laptop 130d), 2) analyzing the communication and determining which access device may capable of executing a task (e.g., writing a document) and 3) transmitting a signal associated with another communication to the chosen access device. Those capabilities lend the application chat server 120 to enable a web service, a method of communication between devices. As stated previously, application chat server 120 transmits a signal via a wireless or wireline transmission channel 150 to at least one access device, such as smartphone 130a.

User X's grouping of access devices 130 is generally representative of one or more access devices such as a smartphone 130a, a tablet 130b, a desktop computer (herein referred to as “desktop”) 130c and a laptop 130d. In addition, each access device may be mobile or non-mobile. For example, a mobile and/or non-mobile access device may take the form of a personal computer, workstation, personal digital assistant, mobile telephone, smartphone, APPLE® iPad, and/or any other device capable of providing an effective user interface with a server and/or database.

FIG. 1A illustrates an exemplary sub-system 100A between the application chat server 120 and the laptop 130d. While this sub-system is between laptop 130d and application chat server 120, one skilled in the art would appreciate that the description and/or parts of the description of FIG. 1A are applicable to other access devices. Laptop 130d is an exemplary access device which includes a graphical interface 138, a processor module 131, a memory 132, and a keyboard 134. All of these elements are connected via computer bus 101, which is shown in various pathways throughout the laptop 130d.

Processor module 131 includes one or more processors, processing circuits, and/or controllers. In the exemplary embodiment, processor module 131 takes any convenient and/or desirable form known to those skilled in the art. Coupled, via computer bus 101, to processor module 131 is memory 132.

Memory 132 and hard drive (not shown) are examples of main memory and secondary memory, respectively. In this document, the terms “computer program medium,” “computer usable medium,” and “computer readable medium” may generally refer to media such as main memory, secondary memory, removable storage drive, a hard disk installed in a hard disk drive and/or other media known to those skilled in the art. The computer readable medium, for example, may include non-volatile memory, such as a floppy disk, ROM, flash memory, disk drive memory, a CD-ROM, a CD-optical drive or disc and/or other permanent storage. Additionally, a computer readable medium may include, for example, volatile storage such as RAM, buffers, cache memory, and/or network circuits. The processor module 131 reads data, instructions, messages or message packets, and other computer readable information from the computer readable medium.

In one exemplary embodiment, memory 132 stores code (machine-readable or executable instructions) for an operating system 136 and registration software 135. Operating system 136 is coupled to a graphical interface 138 and other various components thereof, via computer bus 101. In the exemplary embodiment, operating system 136 takes the form of a version of the Microsoft®Windows® operating system, and browser 1383 takes the form of a version of Microsoft® Internet Explorer®. Another exemplary operating system 136 and browser 1383 may be a version of Apple® Mac Os and Apple® Safari, respectively. One skilled in the art would appreciate that components within an access device, such as an operating system and a browser, may have various different forms and/or versions. In addition, operating system 136 interacts, via computer bus 101, with the keyboard 134, the processor module 131 and the registration software 135. For example, the keyboard 134 sends inputs, via computer bus 101, to the operating system 136. The operating system 136 determines that the registration software 135 is active, accepts the registration software input as data and stores that data temporarily in memory 132 (e.g. RAM). Each instruction from the registration software 135 is sent by the operating system 136, via computer bus 101, to the processor 131. These instructions are intertwined with instructions from other programs that the operating system 136 is overseeing before being sent to the processor 131. Operating system 136 and browser 1383 not only receive inputs from keyboard 134, but also support rendering of graphical user interfaces within graphical interface 138.

Graphical interface 138 includes a browser 1383 and a display 1381. When the application chat (AppChat) module 140 is initiated, a display 1381 is defined in memory 132 and rendered on graphical interface 138. Upon rendering, the graphical interface 138 presents the data/results in association with the set of instructions from the AppChat module 140 as further discussed herein.

Application chat server 120 includes a processor 121 and a memory 122, wherein the memory 122 further includes an AppChat module 140, a search module 123, a device database 110 and a command queue 105. Processor 121 and memory 122 are connected via computer bus 102, which is shown in application chat server 120. Computer buses 101 and/or 102 are buses that transmit information between the access device's components/elements and/or between multiple access devices. For example, computer bus 101 and computer bus 102 aid in transmitting information (e.g., a signal) within laptop 130d and application chat server 120, respectively. Processor 121 may use computer bus 102 to queue a request that is to be transmitted through a signal, from application chat server 120, via a wireless or wireline transmission channel 150 and is then ultimately received by the processor module 131 through the utilization of computer bus 101. Generally, application chat server 120 transmits the signal via a wireless or wireline transmission channel 150 to at least one access device, such as laptop 130d.

Processor 121 includes one or more local and/or distributed processors, controllers and/or virtual machines. In the exemplary embodiment, processor module 121 takes any convenient and/or desirable form known to those skilled in the art. Memory 122 takes the exemplary form of one or more electronic, magnetic, and/or optical data-storage devices and stores an application chat (AppChat) module 140, a search module 123, a device database 110 and a command queue 105.

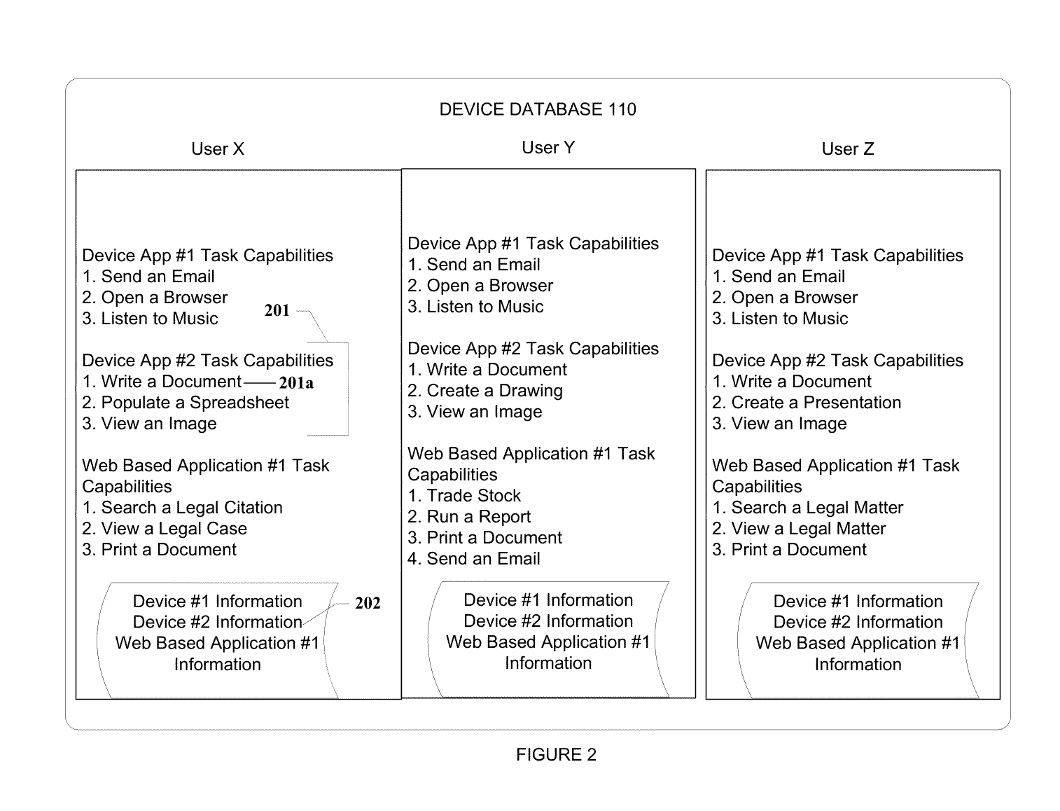

Search module 123 includes one or more search engines and related user-interface components (not shown), for receiving and processing queries against the device database 110 and/or the command queue 105. Device database 110 takes the exemplary form of one or more electronic, magnetic, and/or optical data-storage devices. Device database 110 includes information about the access devices and web based applications associated with a given user. Web based applications are discussed further in the specification. For example, FIG. 2 is an exemplary device database 110 wherein information is stored about the access devices associated with users X, Y and Z, respectively. Exemplary information about each access device includes but is not limited to a statement of task capability and/or device information. For instance, in FIG. 2, an exemplary statement of task capability for device app #2 for user X is “write a document” 201a. Exemplary device information includes but is not limited to a unique device identifier, a global positioning system (GPS) location, an access device type and an access device registration code. While the unique device identifier, the global positioning system (GPS) location, the access device type and the access device registration code are not specifically referenced in FIG. 2, this information is part of device #2 information 202. Other information regarding the users may also be stored within the device database 110. For example, a relationship between the access device and a given user may be stored within the device database 110. Again in FIG. 2, there are three (3) exemplary users wherein each user has one or more access devices associated with the given user. For example, user Z has registered two access devices and those registrations have been stored within the device database 110. In addition, each access device is associated with at least one statement of task capability. Continuing from the previous example, the statements of task capabilities for device app #1 include 1) send an email, 2) open a browser and 3) listen to music. The statement of web based application task capabilities will be described in another embodiment. The statement of task capability along with the relationship of which access device the statement of task capability associates with is stored in device database 110. In addition, the statement of task capability may be an individual task capability and/or may also be an aggregate of all the task capabilities for a given access device. For example, if laptop 130d has three (3) task capabilities, the registration signal for the laptop 130d may include three (3) individual statements of task capability or one (1) combined statement of task capability for the three (3) task capabilities.

Referring back to FIG. 1A, AppChat module 140 is configured to conduct exemplary method 300. In one embodiment, the AppChat module 140 is configured to register two or more access devices to an account associated with the application chat server 120. The account may be associated with a particular user and/or entity. For example, user X may register two access devices, a smartphone 130a and a laptop 130d. Therefore the account is associated with user X. In another example, Company B may register one hundred (100) access devices and the account may be associated with Company B. Furthermore, an access device may be associated with one or more accounts if an individual user registers the access device and a company registers the same access device. This application may be beneficial in situations where the access devices are owned by the company but are provided to the individual user during his/her employment with the company. The AppChat module 140 is also configured to receive, via the application chat server 120, a first statement of task capability and a second statement of task capability associated with a first access device and a second access device, respectively. Additionally, the AppChat module 140 is configured to analyze, based upon one or more of the first and second statements of task capability, a task command to determine that the second access device is capable of executing a task. Furthermore, the AppChat module 140 is configured to generate an execution command associated with the task. The execution command generation is responsive to a determination that the first access device executes the task. The AppChat module 140 is configured to transmit an execution signal associated with the execution command. While current and future examples may refer to a single task, one skilled in the art will appreciate that other exemplary embodiments may include more than one task.

In another embodiment, the AppChat module 140 is configured to verify, via the application chat server 120, an association between a first access device and a second access device, the first access device and the second access device associated with a first statement of task capability and a second statement of task capability, respectively. The AppChat module 140 is also configured to analyze, based upon one or more of the first and second statements of task capability, a task command to determine that the second access device executes at least one task. The AppChat module 140 is configured to generate an execution command associated with the task. The execution command generation is responsive to a determination that the first access device executes the task. The AppChat module 140 is configured to transmit an execution signal associated with the execution command.

### Exemplary Method as Conducted by System 100

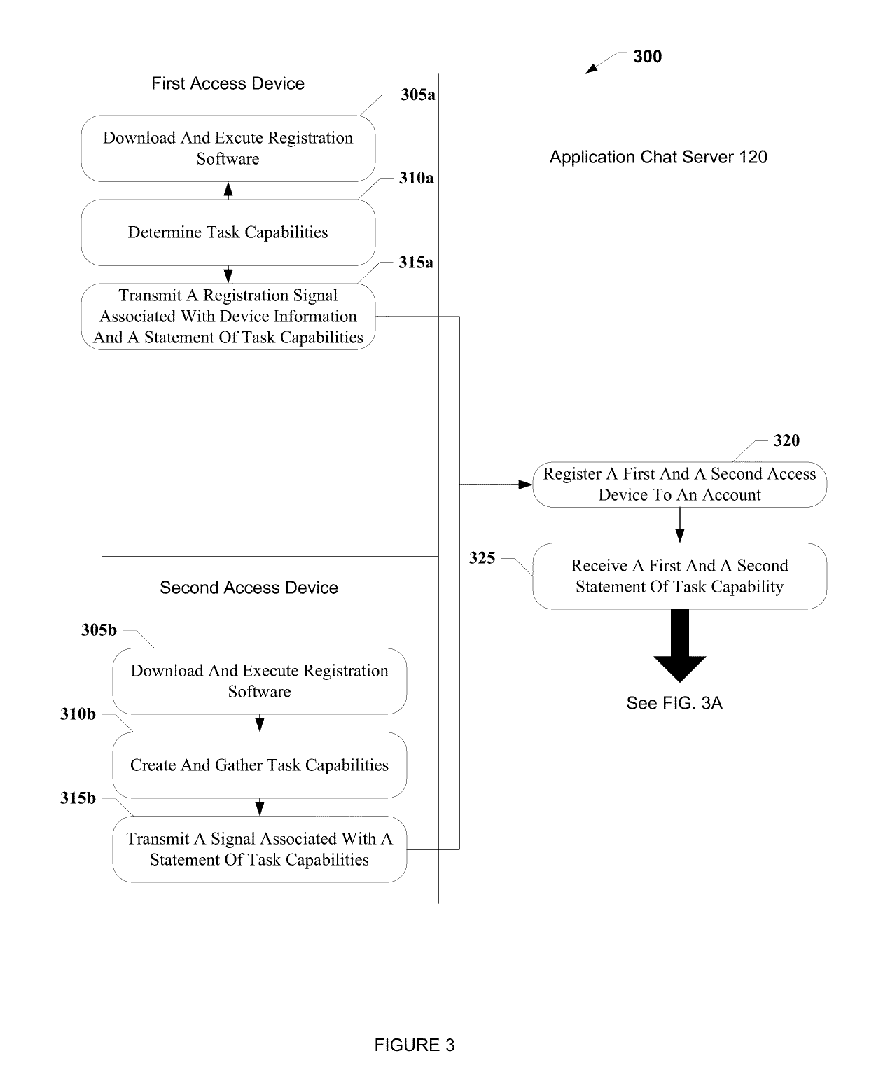

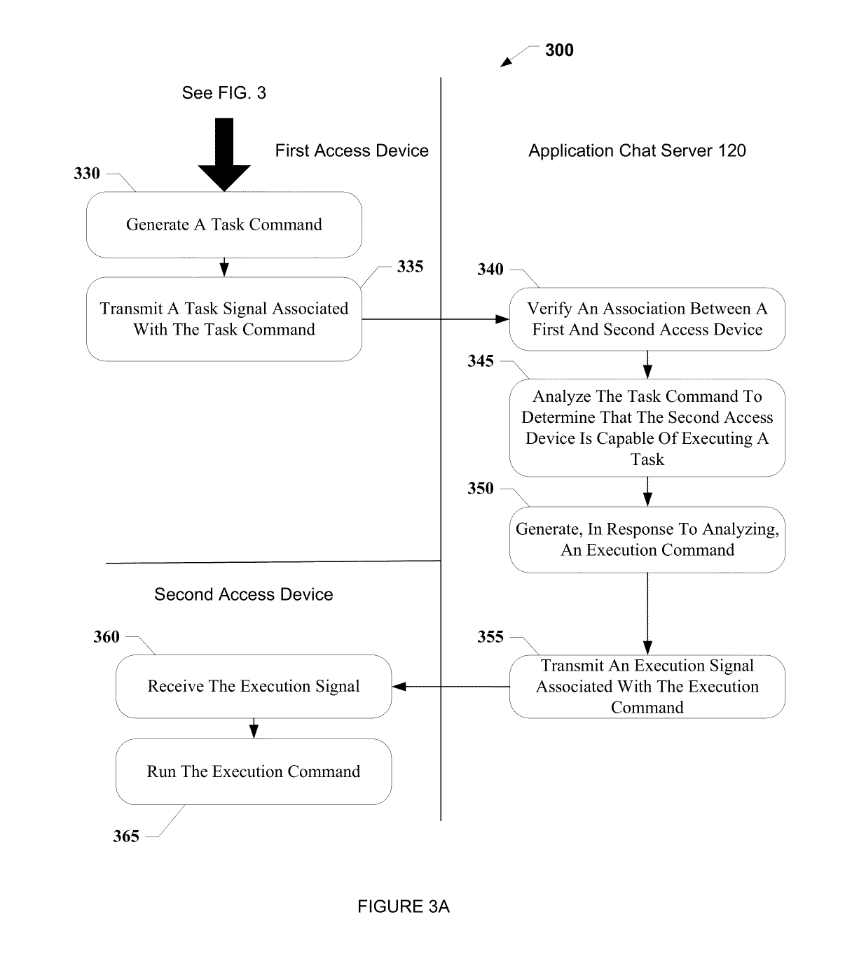

Referring now to FIGS. 3 and 3A, system 100 is configured to implement method 300. Method 300 includes functional blocks 305a-365. These functional blocks are steps that perform actions including assignments, decisions, assessments and other like functions.

In steps 305a and 305b, the registration software 135 is downloaded and executed on first and second access devices, respectively. For example, the registration software 135 may be downloaded and initiated on an exemplary access device such as laptop 130d. The registration software 135 initiates using a combination of the processor 131 and the operating system 136. Once the registration software 135 is downloaded and initiated for each of the first and second access devices, the process moves to steps 310a and 310b, respectively.

In steps 310a and 310b, the registration software 135 is executed on each of the first and second access devices, respectively, and determines a set of task capabilities associated with each access device. One of the purposes of the registration software 135 is to communicate with applications on the given access device, via computer bus 101, to determine what tasks the given access device is capable of performing. For instance, the registration software 135 may use application catalogue functionality to dynamically create a list of available applications (and their corresponding tasks) installed on an access device. An example of component catalogue functionality may be the cataloging function used in Microsoft's® Managed Extensibility Framework (MEF). After the registration software 135 determines what the task capabilities are for a given access device, the registration software 135 creates a statement of task capability for each task. For example, a first access device may be laptop 130d and the registration software 135 may communicate with Microsoft® Outlook to determine that the laptop 130d, via Microsoft® Outlook, is capable of drafting and sending an email. Consequently, the statement of task capability may state: “send an email.” The statement of task capability is formatted in a way so that the application chat server 120 may process the information.

In some embodiments, the registration software 135 may be a mobile application. For example, a mobile application may be a generic appchat application that is downloaded onto a mobile access device such as tablet 130b. This generic appchat application would only be able to determine the task capabilities of the tablet 130b. For example, the tablet 130b may be capable of opening a browser 1383, playing a song, making a phone call, sending an email and/or adding a calendar event. The generic appchat application is not capable of determining the task capabilities of other mobile applications within tablet 130b. For example, if there is a mobile application that presents long division problems, the generic appchat application does not know about that mobile application and therefore cannot inform the application chat server 120 of the long division task capability. That being said, later exemplary embodiments address the task capability of web based applications. In either embodiment, after the registration software 135 determines the task capabilities and creates statements of task capabilities related to those task capabilities for each of the first and second access devices, the process moves to steps 315a and 315b for the first and second access devices, respectively.

In steps 315a and 315b, each of the first and second access devices, respectively, transmit a registration signal. The registration signal is associated with at least one statement of task capability and device information. In addition, the registration signal is transmitted via the wireless or wireline transmission channel 150. An exemplary transmission channel 150 uses a communication protocol. In some instances, the communication protocol needs to be encrypted to protect the information from unauthorized use. For example, a Hypertext Transfer Protocol Secure (HTTPS) communication protocol is a secure protocol that combines the Hypertext Transfer Protocol (HTTP) with SSL/TLS. The Transport Layer Security (TLS) and its predecessor, Secure Sockets Layer (SSL), are cryptographic protocols that provide communication security over the internet. While the exemplary embodiments follow the HTTPS protocol, one skilled in the art will appreciate the implementation of other and/or additional protocols to communicate. An access device transmits a registration signal and the process moves to step 320.

In step 320, the first and second access devices are registered to an account. Part of the registration process may be to receive, via the registration signal, information about each access device and then to store the given device information within the device database 110. For example, a first access device is a laptop 130d. After and/or during previous steps 305a-315a, the laptop 130d ultimately transmits a registration signal that is associated with device information. For example, the laptop device information may include a unique identifier, the current location of the laptop 130d and an indication that the given access device is a laptop device. Another part of the registration process includes moving to step 325.

In step 325, the application chat server 120 receives the registration signal that further includes a statement of task capability. The statements of task capability, along with the previously mentioned device information, are then stored within the device database 110. The structure of the storage correlates with the account of the registered access device. For example, if a first statement of task capability associated with a first access device is received, the relationship between the statement of task capability and the device information is stored within the device database 110 under a given account. This registration process, including steps 305-325, continues with each access device that can receive the registration software 135.

In some embodiments, if a new application is downloaded onto an access device after registration, the previously mentioned application catalogue functionality updates the list of available applications (and their corresponding task capabilities). The given access device transmits, via the wireless or wireline transmission channel 150, a signal associated with the one or more additional task capabilities to the application chat server 120. The application chat server 120 receives the signal associated with the one or more additional task capabilities and adds them to the listing of task capabilities for the given access device.

In some embodiments, a user may want to add and/or remove an access device from the list of registered access devices. For example, a user may have a Blackberry® smartphone registered with the application chat server 120 but wants to replace it with an Apple® iPhone® smartphone. The user needs to unregister the Blackberry® smartphone and register the Apple® iPhone® smartphone. In order to perform this operation, the user has to indicate through interfaces, possibly provided by the registration software 135, that the Blackberry® smartphone should no longer be registered. An exemplary interface (not shown) may allow the user to remove the access device from the listing of access devices registered under the user's account. Then the user may add the Apple® iPhone® smartphone by registering it using the systems and methods described herein. Once the first and second access devices are registered then the process continues to step 330 in FIG. 3A.

In step 330, a first access device generates a task command. The generation of the task command may have initiated two ways: through user initiation and/or access device initiation. For example, a first access device is a smartphone 130a. A user initiation may be a user engaging with the smartphone 130a and deciding to initiate a task of writing a letter. User selection of the task may occur by the user interacting with one or more interfaces that gather information about what task the user wants to accomplish and/or which access device, if any, should execute the given task. An access device initiation may be the smartphone 130a deciding to initiate a task of writing a letter based on system procedure. Either way, the task is writing a letter. Therefore, a task command is generated based on the task of writing the letter. Ultimately, this task command is received by the application chat server 120. Therefore the task command contains properties that assist the application chat server 120 in making a decision about which access device should execute the task. An exemplary task command from an access device is shown below. Each of the exemplary properties is described herein.

Task Command A Properties

Target:
Broadcast Type:
Command:
User Context:
Device Context:
Additional Information:

A target property contains information regarding which access device is to execute the task. This property gets populated in cases where the user has selected a specific access device to execute a task. For example, if the user wants to write a letter but only has access to a smartphone 130a, the user may specifically elect, via one or more interfaces, to send the task of writing a letter to his laptop 130d. In another example, the user may specifically elect, via one or more interfaces, the laptop 130d as a default device each time the task of writing a letter is selected. If the target property is left blank, the application chat server 120 determines which access device executes the task. A broadcast type property contains information about how many access devices might execute the task. Exemplary broadcast types include but are not limited to one access device per account, all access devices per account and/or a combination of access devices per account. For example, if the target property selects a specific access device, the broadcast type would be one access device because the user, via one or more interfaces, selected that given access device. In another example, if the target property is blank, the broadcast type may be all access devices. This example allows the application chat server 120 to send the task, via the execution command, to all access devices to see which access device or devices can execute the task. This situation may be beneficial when all the access devices have the capability of executing the given task. In another example, the broadcast type may be a combination of access devices. This scenario is particularly helpful when the application chat server 120 knows certain access devices are capable of executing the task and the user has not selected a specific access device. A command property contains the instructions on what task needs to be performed. Usually these instructions are in the form of a command. For example, the task the user may want to accomplish is writing a letter. The command for this task may be to open a word processing application installed on an access device. The user context property contains user information such as a user identification, an account number, and a user-selected username. The device context property contains previously described access device information about the first access device (e.g., the access device initiating the task). The user information and the device information allows the application chat server 120 to verify the first access device is associated with a given account number. Finally, the additional information property contains information that may be relevant to the access device that executes the task. Exemplary additional information may include but is not limited to a unique resource locator (URL), a company name, a company stock ticker, a character string, a file location, a combination and the like. Once the task command is generated, the process moves to step 335.

In step 335, a task signal is transmitted. The task signal is associated with at least one task command. In addition, the task signal is transmitted via the wireless or wireline transmission channel 150. After the task signal has been transmitted, the process advances to step 340.

In step 340, the application chat server 120 verifies an association between a first access device and a second access device. For example, referring back to FIG. 1, smartphone 130a may be the first access device and a laptop 130d may be the second access device. In this example, the application chat server 120 verifies that the smartphone 130a and the laptop 130d have an association. This association may be a registration to the same account. Verification processes are known to those skilled in the art. For example, during the registration process, the user had to register each access device to an account. Assuming that the user registered the smartphone 130a and the laptop 130d to the same account, the user creates the association between the access devices by simply registering each access device under the same account. When verifying the association is complete, the process continues to step 345.

In step 345, the application chat server 120 analyzes a task command to determine that the second access device is capable of executing a task. The analysis is based upon one or more task capabilities. The one or more task capabilities may be associated with a first access device and/or a second access device. While current and future examples may refer to a single task, one skilled in the art will appreciate that other exemplary embodiments may include more than one task. In particular, the application chat server 120 receives the task signal from the first access device and, then, analyzes the task command that is associated with the received task signal. In order to analyze the task command, the application chat server 120 references the device database 110, in particular, the statements of task capability for each registered access device within an account. For example, referring back to FIG. 2, the device database 110 has a listing of two (2) access devices for user X's account. Each registered access device has a listing of statements of task capabilities (e.g., device app #2 task capabilities 201) associated with the corresponding access device. In the current example, a listing of one of device app #2 task capabilities 201 includes the capability to write a document. If, for example, the task command is related to writing a document, the analysis may determine that device app #2 has that capability. In some embodiments, more than one access device may be capable of executing the task. In this instance, the application chat server 120 may have to consider other factors besides the statements of task capability. The device information is particularly helpful in these instances. For example, if user Y's account has two (2) registered access devices and each are capable of writing a document, then the application chat server 120 may turn to each set of device information to determine a specific access device to execute the task. For instance, the application chat server 120 may see that device app #1's GPS location is somewhere in New York City and device app #2's GPS location is somewhere in Atlanta. If the task command has additional information that states the origin of the task command occurred in Atlanta, then the application chat server 120 may determine that device app #2 is closer. Therefore the application chat server 120 chooses device app #2 to be more capable of executing the task. That being said, in other embodiments, the determination may be that more than one access device will be sent an execution signal to execute the task. In that case, the application chat server 120 may only need to determine that multiple access devices are capable. Yet in other embodiments, the application chat server 120 may already know which access device is going to execute the task because of the broadcast type and/or target properties within the task command. Once a determination of which access device or access devices are capable of executing the task, the process advances to step 350.

In step 350, an execution command is generated in response to step 345. The execution command is associated with at least one task. As similar to the task command, the execution command has properties. Generally, these properties are similar to the task command. For example, the task command may include additional information such as a URL. The application chat server 120 does not do anything with this information but instead passes this information along in the execution command. In some embodiments, all of the task command properties are included in an execution command. In other embodiments, the application chat server 120 may remove certain properties that are irrelevant to the execution of the task. For example, the broadcast type may be removed after the application chat server 120 already determined which access device is capable of executing the task. Once the execution command is generated, the process progresses to step 355.

In step 355, an execution signal is transmitted. The execution signal is associated with the execution command. In addition, the execution signal is transmitted via the wireless or wireline transmission channel 150. After the execution signal has been transmitted, the process advances to step 360.

In step 360, a second access device receives the execution signal. In particular, the processor 131 and/or operating system 136, via computer bus 101, receive the execution signal and determine how best to execute the execution command associated with the execution signal. In some embodiments, there may an indication of a specific device application that is capable of executing the task. For example, in the additional information property of the execution command, the information may have a preference to write a document using Microsoft® Word (i.e., device application) instead of WordPerfect®. In those instances, the processor 131 and/or operating system 136 determine that the specified device application should execute the execution command. In other embodiments, the execution command remains silent as to which application may execute the task and the processor 131 and/or operating system 136 have to determine the best application for the task. Once the execution signal is received and a determination of which application should execute the task, the process advances to step 365.

In step 365, the execution command runs against the device application that the processor 131 and/or the operating system 136 have chosen. By running the execution command, the device application ultimately executes the command property within the execution command. The device application may also use other properties within the execution command to fully execute the execution command and thus the task. For example, the additional information may have URL information that the device application may utilize in order to complete the command related to the task. Further examples are described herein.

### Exemplary Systems 400, 500 and 600

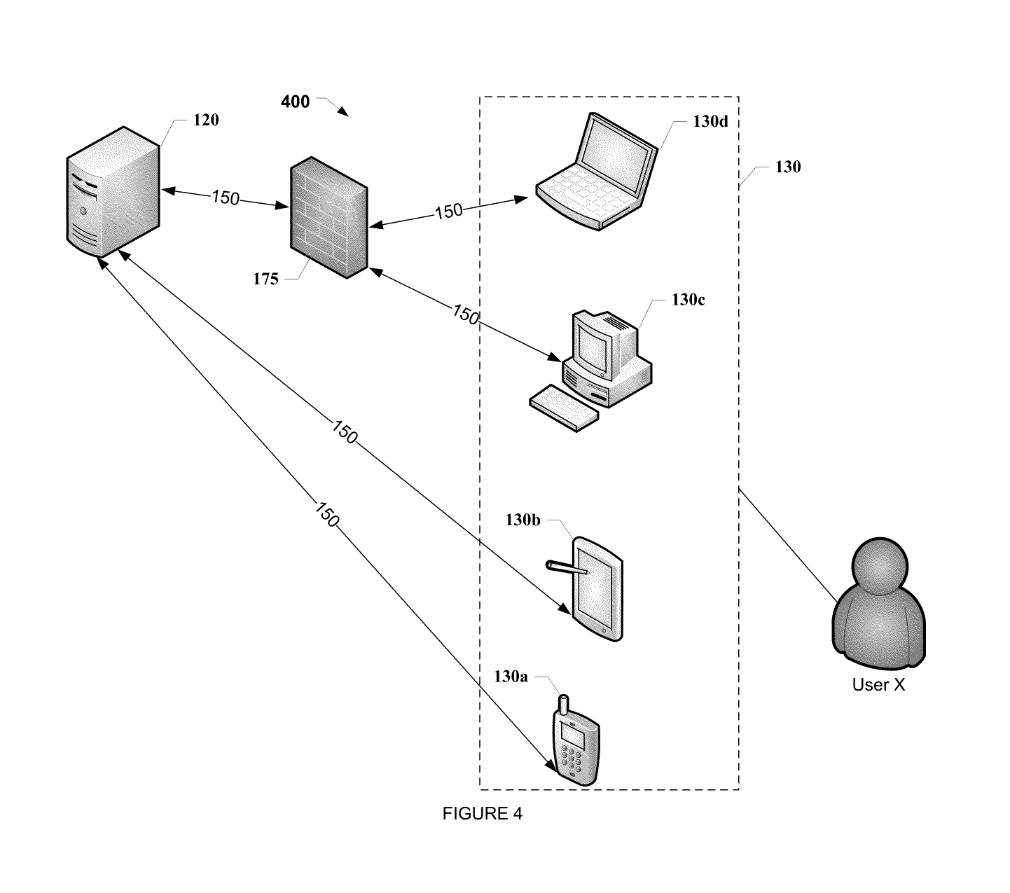

FIGS. 4-6 show exemplary systems 400, 500 and 600, respectively, which may be adapted to incorporate the capabilities, functions, methods, and interfaces of the present invention.

FIG. 4 illustrates exemplary system 400 including the previously described application chat server 120, the previously described user X's grouping of access devices 130 and a firewall 175. Firewall 175 is a device or set of devices designed to permit or deny a wireless or wireline transmission channel 150 based upon a set of rules. The firewall 175 is frequently used to prevent unauthorized access while permitting legitimate transmissions to pass. In some embodiments, the operating system 136 may include one or more software-based firewalls to protect against threats from the public internet. Additionally, firewall 175 may perform basic routing functions. For example, firewall 175 may route all the incoming and outgoing signals via the wireless or wireline transmission channel 150 for desktop 130c and laptop 130d. In order to pass through the firewall 175, the signals must contain certain information (e.g., HTTPS encryption) that ultimately allows the passage of the signal.

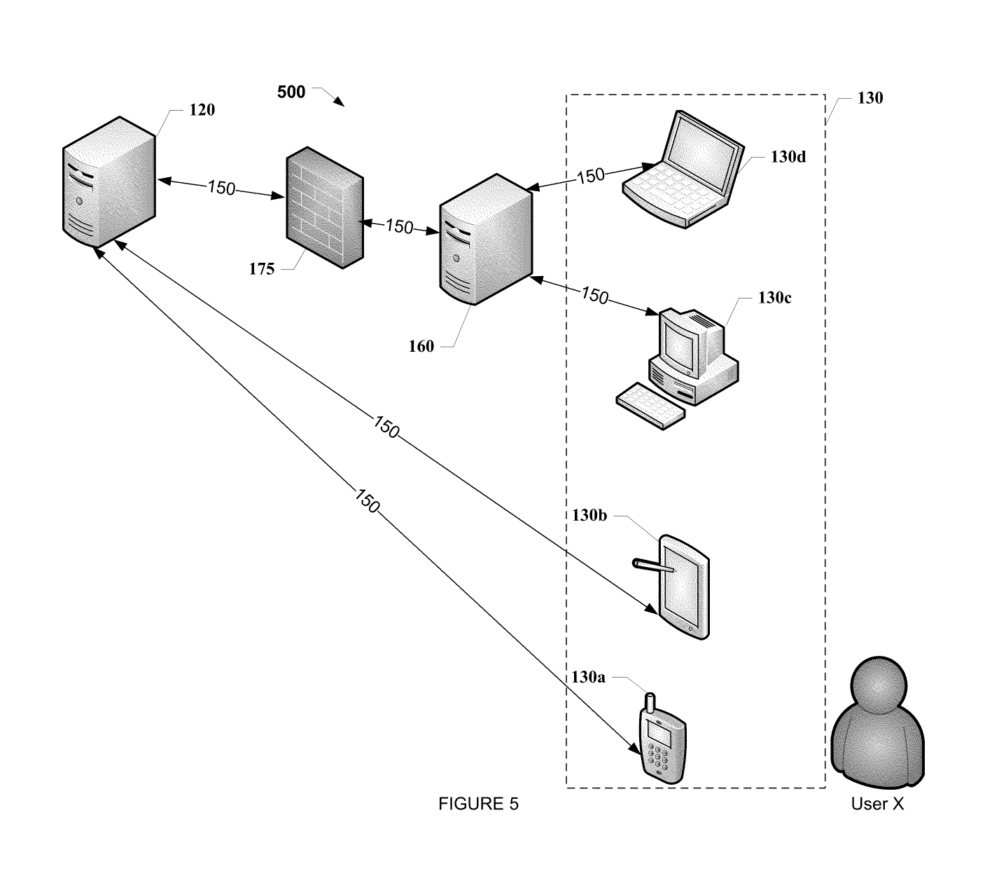

FIG. 5 illustrates exemplary system 500 including the previously described application chat server 120, the previously described grouping of access devices 130, the previously described firewall 175 and an enterprise server 160. The enterprise server 160 is a server or set of servers containing programs that collectively serve the needs of an enterprise (e.g., an entire company) rather than a single user, department, or specialized application. The enterprise server 160 may incorporate part or all of the capabilities, functions, methods, and/or interfaces of the application chat server 120. In some embodiments, the enterprise server 160 contains the computer hardware and its main software, the operating system (not shown). The enterprise server 160 may provide an extra layer of security, an additional filter on the task and/or execution commands and/or additional information. For example, firewall 175 may allow an execution signal associated with an execution command to pass through and be further transmitted to the enterprise server 160. However, the enterprise server 160 may determine, for inter-company security reasons, the execution signal should be transmitted back to the application chat server 120 because it did not include a set of inter-company credentials. In another example, the enterprise server 160 may receive the execution command associated with a task. The enterprise server 160 determines that the execution command should be ultimately executed on the desktop 130c instead of the laptop 130d due to the larger processor of the desktop 130c. Therefore, the enterprise server 160 may transmit the execution signal to the desktop 130c as opposed to the laptop 130d. In yet another example, the enterprise server 160 may provide and/or contain additional information that may be relevant to the task command and/or the execution command. For the task command instance, the desktop 130c may have the task capability to trade stocks. The execution signal associated with the task is transmitted through the enterprise server 160 before reaching the application chat server 120. However, the enterprise server 160 may decide to remove this task (i.e., the statement of task capability) for security reasons. That being said, the enterprise server 160 may keep a record of the given statement of task capability in case an execution command is transmitted back and the enterprise server 160 determines that the execution signal associated with an execution command is secure and may be executed on the desktop 130c, for example.

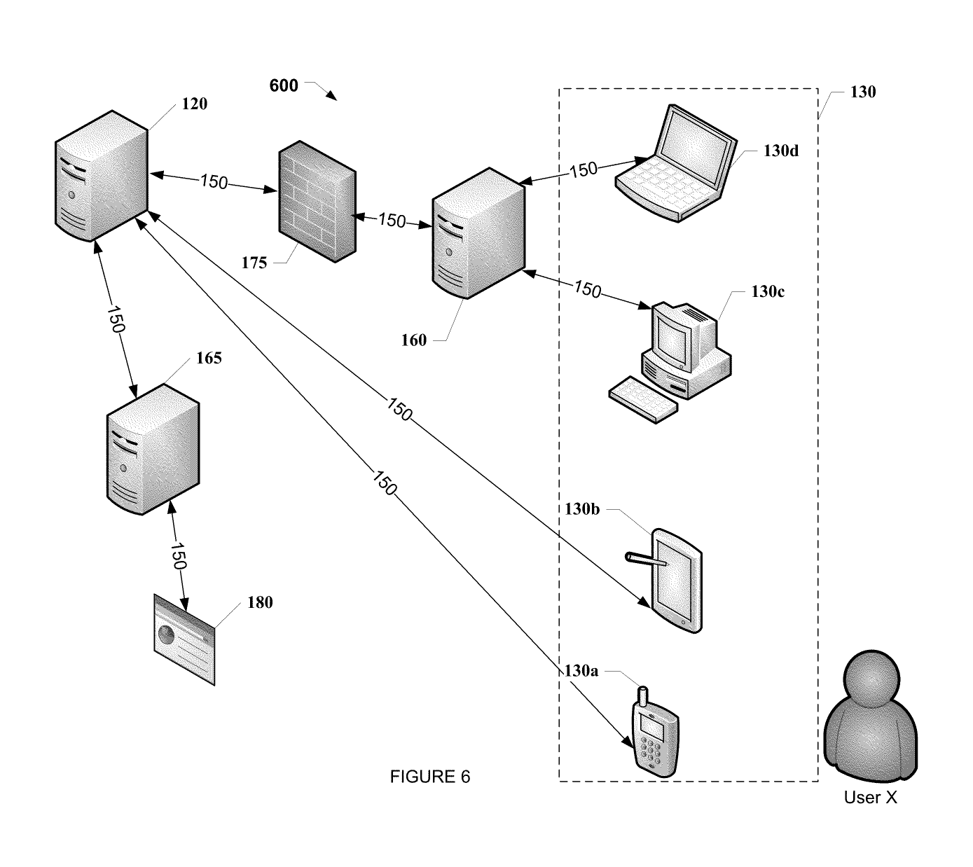

FIG. 6 shows exemplary system 600 including the previously described application chat server 120, the previously described grouping of access devices 130, the previously described firewall 175, the previously described enterprise server 160, a web server 165 and a web based application 180. The web based application 180 is independent of a specific access device but it is dependent on a web server 165 and a browser 1383. A web server 165 can refer to either the hardware (the computer) or the software (the computer application) that helps to deliver content that can be accessed through the Internet. The most common use of web servers is to host websites, but there are other uses such as gaming, data storage or running enterprise applications. One primary function of a web server 165 is to deliver web pages on the request to clients. This means delivery of HyperText Markup Language (HTML) documents and any additional content that may be included by a document such as images, style sheets and scripts. The browser 1383 initiates communication by making a request for a specific resource using HTTP and the web server 165 responds with the content of that resource or an error message if unable to do so. The web server 165 is configured to create an instance of a web based application 180. For example, Google® has a series of web servers wherein any of the web servers may create an instance of the Google® website as a user requests the URL, www.google.com. In one example, a web based application 180 may be an online legal research system, WestlawNext®. In another example, a web based application 180 may be an online trading application such as e*Trade®.

Each exemplary web based application mentioned previously is subscription based. Therefore, login credentials may be required to access the functionality of the web based application 180. In some embodiments, the web based application 180 is configured to initiate on a browser 1383 within one of user X's grouping of access devices 130 that are previously registered. For instance, the web based application 180 is configured to initiate on browser 1383 within laptop 130d. In other embodiments, the web based application 180 is configured to initiate on a browser 1383 within a non-registered access device. For example, the web based application 180 is configured to initiate on a browser 1383 within a public computer in a library.

### Exemplary Method as Conducted by System 600

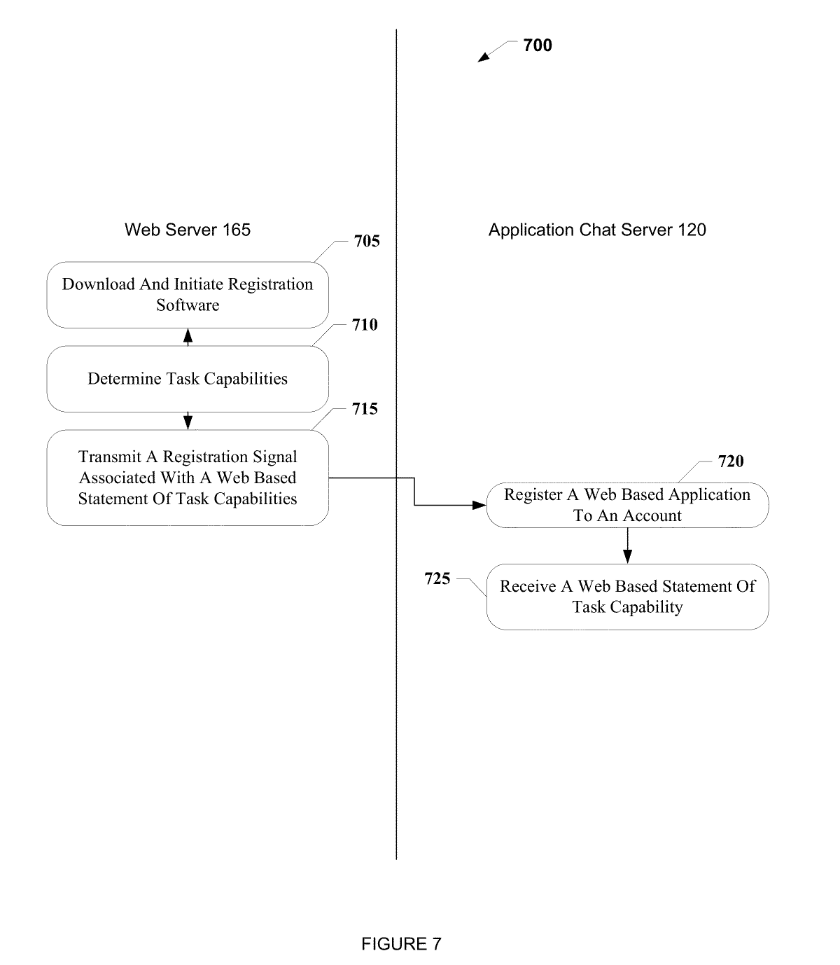

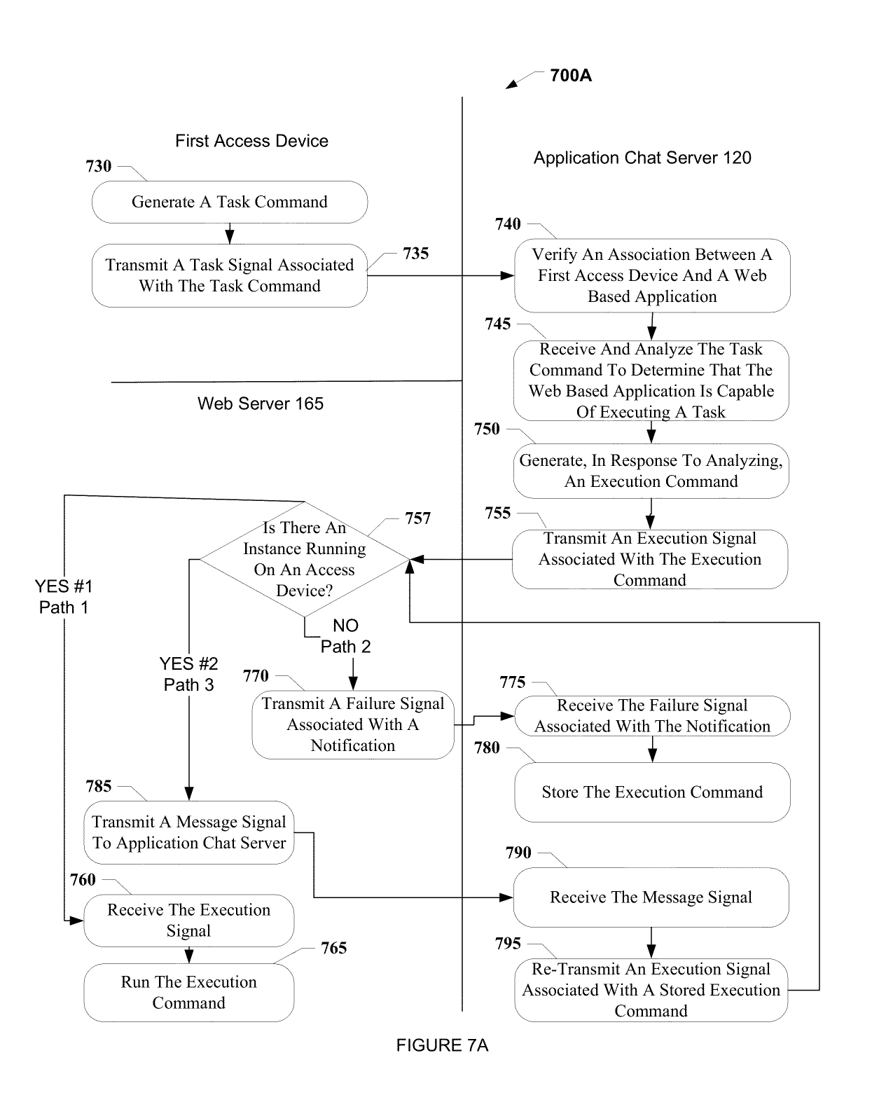

Referring now to FIGS. 7 and 7A, system 600 is configured to implement methods 700 and 700A, respectively. Methods 700 and 700A include functional blocks 705-725 and 730-795, respectively. These functional blocks are steps that perform actions including assignments, decisions, assessments and other like functions.

In step 705, the registration software 135 is downloaded and executed on web server 165. Each web based application 180 that wants to be part of system 600 needs to have the registration software 135 installed on at least one corresponding web server 165. The registration software 135 initiates using a combination of a processor (not shown) and an operating system (not shown) within the web server 165. The registration software 135 gets installed on at least one web server 165 that associates with a web based application 180. For example, the web servers that correspond to a WestlawNext® web based application need to download and install the registration software 135. Furthermore, the web servers that correspond to an Asset4® web based application need to download and install a separate, individual instance of the registration software 135. Once the registration software 135 is downloaded and initiated for at least one web server 165 associated with a web based application 180, the process moves to step 710.

In step 710, the registration software 135 runs on the web server 165 and determines a set of task capabilities associated with a web based application 180. One of the purposes of the registration software 135 is to communicate with applications of the web server 165, via computer bus (not shown), to determine what tasks the web based application 180 is capable of performing. For example, a web based application 180 is WestlawNext®. The registration software 135 may communicate with the web server 165 associated with WestlawNext® to determine that WestlawNext® is capable of executing legal document searches with a user query. After the registration software 135 determines what the task capabilities are for a given web based application 180, the registration software 135 creates a web based statement of task capability for each task. The web based statement of task capability is formatted in a way so that the application chat server 120 may process the information.

In some embodiments where mobile applications are downloaded on a mobile access device, such as tablet 130b, the mobile application may include the registration software 135 in order for the mobile application to communicate with the application chat server 120. In addition, the registration software 135 ultimately provides the application chat server 120 with task capability for each web based application 180 and, if possible, includes which access device the registration software 135 is downloaded on. Embedding the registration software 135 within the mobile application permits a finer grain of tasks within the mobile application and may avoid the need for a separate generic appchat application. For example, if user X decides to download a mobile application for WestlawNext®, embedded within that mobile application is the registration software 135. While the mobile application is being downloaded, the registration software 135 is to be downloaded and executed against the capabilities of the mobile application. The instances of mobile applications and/or web based applications have a couple of significant benefits. The first benefit understands the full capability of an access device. Several mobile access devices have limited task capability without the mobile applications. In other words, mobile applications are what give the mobile access devices the capability to perform tasks. By embedding the registration software 135 within the mobile application, the mobile access device inherently has more task capability when considering the capabilities of the mobile applications. The second benefit allows for cross-mobile application/web based application communication. Generally, the mobile access device does not know the capability of each mobile application or web based application. In addition, each mobile application and web based application and/or the combination does not communicate with and/or know about other mobile applications. For example, if you are opening a browser 1383 on tablet 130b, a long division mobile application does not know what the browser 1383 is doing. Additionally, the tablet 130b is not aware of what is happening within the web based application 180 on the browser 1383 and/or the long division mobile application. This functionality allows support for specific challenges in more constrained environments such as the Apple® iPad and Microsoft® Windows® 8 Tablet Metro design. For example, user X on an access device that uses Microsoft® Windows® 8 is engaging a matter management system to review business activities. The user wishes to act on a matter by writing an email. Interacting with one or more interfaces (not shown), the user clicks on a button labelled “Task” then other options (tasks) are displayed including “send an email.” Upon the user selecting “send an email,” the given access device activates Microsoft® Outlook to execute the task of sending an email. This example would not be previously possible without writing time consuming and potentially expensive middle ware to manage cross application communications. After the registration software 135 determines the task capabilities and creates web based statements of task capabilities related to those task capabilities, the process moves to step 715.

In step 715, the web server 165 transmits a registration signal. The registration signal is associated with at least one web based statement of task capability and web based application 180 information. In addition, the registration signal is transmitted via the wireless or wireline transmission channel 150.

In step 720, the web based application 180 is registered to an account. Part of the registration process may be to receive, via the registration signal, information about the web based application 180 and then to store the given web based application information within the device database 110. For example, a web based application 180 may be a subscription-based, online information retrieval application. After and/or during previous steps 705-715, the web server 165 ultimately transmits a registration signal that is associated with the web based application information. The web based application information may include a unique application identifier, a corresponding web server location, a web based application type and the like. In the previous example, subscription-based, online information retrieval application information may include a unique identifier to establish that the web based application 180 is secure, the current location of the web server 165 and an indication that the given web based application 180 is a document retrieval application. Another part of the registration process includes moving to step 725.

In step 725, the application chat server 120 receives the registration signal that further includes a web based statement of task capability. The web based statements of task capability, along with the previously mentioned web based application information, are stored within the device database 110. The structure of the storage correlates with the account the given access device is registered under. For example, if a web based statement of task capability associated with a web based application 180 is received, the relationship between the web based statement of task capability and the web based application information is stored within the device database 110 under a given account. In addition, the web based statement of task capability may be an individual task capability and/or may also be an aggregate of all the task capabilities for a given web based application 180. An example is similar to an above-mentioned example between two access devices. This registration process, including steps 705-725, continues with each web server 165 associated with a web based application 180 that can receive the registration software 135.

FIG. 7A shows method 700A. Steps 730 and 735 are identical to above-mentioned steps 330 and 335, respectively. Refer to steps 330 and 335 for a detailed description. After steps 730 and 735 are complete, the process continues to step 740.

In step 740, the application chat server 120 verifies an association between a first access device and a web based application 180. For example, referring back to FIG. 6, smartphone 130a may be the first access device. In this example, the application chat server 120 verifies that the smartphone 130a and the web based application 180 have an association. This association may be a registration to the same account. As stated previously, verification processes are known to those skilled in the art. When verifying the association is complete, the process continues to step 745.

In step 745, the application chat server 120 analyzes, based upon the web based statement of task capability, a task command to determine that the web based application 180 is capable of executing at least one task. In particular, the application chat server 120 receives the task signal from the first access device and, then, analyzes the task command that is associated with the received task signal. In order to analyze the task command, the application chat server 120 references the device database 110, in particular, the statements of task capability for each registered access device and web based application 180 within an account. For example, referring back to FIG. 2, the device database 110 has a listing of two (2) access devices and one (1) web based application 180 for user X's account. Each registered access device and web based application has a corresponding listing of statements of task capabilities (see FIG. 2 for an example of a listing of device app #2 task capabilities 201). In the current example, one of the statements of task capabilities for web based application #1 is “search a legal citation.” If, for example, the task command is related to searching a legal citation, the analysis may determine that web based application #1 has that capability. In some embodiments, more than one web based application and/or access device may be capable of executing the task. In this instance, the application chat server 120 may have to consider other factors besides task capability. The device information and/or web based application information is particularly helpful in these instances. For example, if user Y's account has a registered access device and a web based application with each being capable of writing an email, then the application chat server 120 may turn to the device information and web based application information to determine which one should execute the task of serving as a tool to write an email. For instance, the application chat server 120 may know that device #1 is capable of writing emails from a corporate email account and web based application #1 is capable of writing emails from a personal email account. If the task command has additional information that states the email should be sent from a personal email account, then the application chat server 120 may determine that the web based application #1 is the best choice. That being said, in other embodiments, the determination may be that more than one access device and/or web based application is sent an execution signal to execute the task. In that case, the application chat server 120 may only need to determine which of the multiple access devices and/or web based applications are capable. Yet in other embodiments, the application chat server 120 may already know which web based application or access device is going to execute the task because of the broadcast type and/or target properties within the task command. Once a determination of which web based application 180 is capable of executing the task, the process advances to step 750.

In step 750, an execution command is generated in response to step 745. The execution command is associated with at least one task. As similar to the task command, the execution command has properties. Generally, these properties are similar to the task command. For example, the task command may include additional information such as a URL. The application chat server 120 only passes this information along in the execution command. In some embodiments, all of the task command properties are included in an execution command. In other embodiments, the application chat server 120 may remove certain properties that are irrelevant to the execution of the task. For example, the broadcast type may be removed after the application chat server 120 already determined a web based application 180 is capable of executing the task. Once the execution command is generated, the process progresses to step 755.

In step 755, an execution signal is transmitted. The execution signal is associated with the execution command. In addition, the execution signal is transmitted via the wireless or wireline transmission channel 150. After the execution signal has been transmitted, the process advances to decision block 757.

In decision block 757, the web server 165 determines whether an instance of the web based application 180 is active on an access device. The access device does not need to be registered to an account within the application chat server 120. There are three paths/determinations following decision block 757. First path, if a determination is made that the web based application 180 is currently active on an access device, then the process moves to step 760. Second path, if the determination is made that the web based application 180 is not currently active on an access device, then the process moves to step 770. Third path, if the determination is made that the web based application 180 is now active on an access device after a period of not being active, then the process moves to step 785. Each path is described herein.

For the first path, in step 760, the web server 165 receives the execution signal. In particular, the processor (not shown) and/or operating system (not shown), via a computer bus (not shown), receives the execution signal. The web server 165 also determines how best to execute the execution command associated with the execution signal. Once the execution signal is received and a determination of how to best execute the task, the process advances to step 765.

In step 765, the execution command runs against the web server 165. By running the execution command, the web server 165 ultimately executes the command property within the execution command. The web server 165 may also use other properties within the execution command to fully execute the execution command and thus the task. For example, the additional information may have a user's query that the web server 165 may utilize in order to complete the command related to the search related task. Further examples are described herein.

For the second path, in step 770, the web server 165 has determined that no instance of a web based application 180 exists on an access device and transmits a failure signal to the application chat server 120. The failure signal is associated with a notification of a failure to perform the execution command against the web server 165 at a given time. For example, the web server 165 determines that a user is not logged in to an exemplary document retrieval application. The web server 165 generates and transmits a failure signal, via wireless or wireline transmission channel 150, to the application chat server 120 stating the web based application 180 (via the web server 165) is not capable of executing the execution command at the current time. Once the failure signal is transmitted, the process proceeds to step 775.

In step 775, the failure signal is received by the application chat server 120. Since the failure signal is associated with a notification of a failure to perform the execution command, the application chat server 120 ultimately knows that the web based application 180, via the web server 165, is not capable of executing the execution command at the current time. Consequently, the process moves to step 780. In step 780, in response to the notification, the execution command is stored in the command queue 105. That stored execution command remains in the command queue 105 until an instance of the web based application 180 occurs. After a period of failure to perform the execution command occurs, the process moves to step 785.

For the third path, in step 785, the web server 165 transmits a message signal. The message signal is associated with a message of an indication that the web based application 180 can now perform a stored execution command. For example, the user has now logged into the web based application 180. The web based application 180, via the web server 165, generates a message signal associated with a message stating that the web based application 180 is now capable of performing any execution commands that may be stored in the command queue 105. Once this determination is made, the process advances to step 790.

In steps 790 and 795, the application chat server 120 receives the message signal and re-transmits an execution signal associated with a stored execution command, respectively. Since the application chat server 120 now knows that the web based application 180 can perform the execution command, the application chat server 120 gathers any stored execution commands marked for the given web based application 180 based on an account and re-transmits, via a wireless or wireline transmission channel 150, an execution signal associated with at least one stored execution command. After the transmission of the execution signal, the process then continues on to steps 760 and 765.

While all three paths described above are exemplary of the web based applications, the same paths may apply to access devices as well. For example, if a laptop 130d is turned off, the execution signal associated with an execution command may not be received by the laptop 130d and therefore a failure signal may be transmitted to the application chat server 120. The application chat server 120 receives the failure signal and stores the execution command in the command queue 105. Once the laptop 130d is running, the laptop 130d transmits a message signal associated with a message stating that the laptop 130d is now capable of performing any execution commands that may be stored in the command queue 105. Finally, the application chat server 120 re-transmits an execution signal associated with the execution command to the awakened laptop 130d and ultimately the laptop 130d executes the execution command. One skilled in the art would appreciate various embodiments where the queuing capability would be beneficial. One example of this is if an access device does not have data service to receive signals or if an access device has become inactive due to timed non-usage (e.g., hibernation). A queuing capability would allow messages to be queued until the access device is active or ready to receive signals.

In some embodiments, the application chat server 120 may be able to initiate a web based application 180 if an active instance does not exist and/or instantiate an instance of an application within an access device. In the web based application 180 instance, the application chat server 120 must have the capability to store and monitor (via device database 110) all active instances within each web based application 180. For instance, the application chat server 120 may use polling techniques known to those skilled in the art to determine which users have instances of a given web based application 180. After polling each web based application 180, the application chat server 120 stores which users have an instance of the web based application 180. If a user does not have an instance, then the execution command properties may include user name and password information regarding how to login an instance of the web based application 180. One skilled in the art would appreciate that security techniques may have to be implemented to assure that the user's information would not be compromised while being transmitted. As for the device application within an access device instance, the application chat server 120 may include a program file name within the additional information in an execution command properties. This program file name may have been included in the device information that was sent during the registration process or it may be included in the task command properties (e.g., the additional information property). Either way the program file name and the relationship of program file name to the task and the given access device would be stored in the device database 110. For example, if a user wanted to write a letter, the application chat server 120 may determine that desktop 130c should execute the execution command. Within that execution command, the additional information property may include the program file name. This way when the desktop 130c receives and executes the execution command, the desktop 130c can use the program file name if an instance of Microsoft® Word®, for example, does not exist currently. The desktop 130c would recognize the program file name and try to execute that program thus bringing up an instance of the program.

### Working Examples

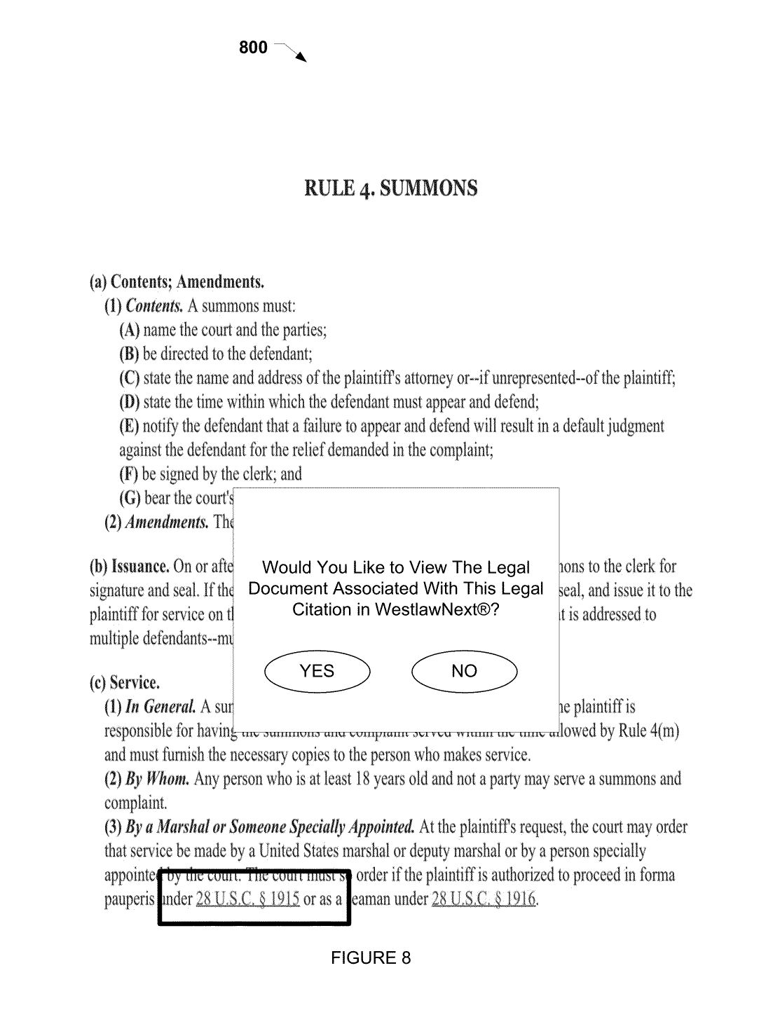

In one working example, user X wants to search a legal citation. The user is on a tablet 130b, reading a legal electronic book (eBook) using eReader software, such as Thomson Reuters ProView™ software. An exemplary interface 800 for a legal electronic book is shown in FIG. 8. While the user is reading through the eBook, he notices a hyperlinked legal citation. The user decides he wants to view the legal document to which the legal citation refers. Once the user selects the hyperlinked legal citation, a pop-up window displays to the user. The pop-up window prompts “Would You Like To View The Legal Document Associated With This Legal Citation In WestlawNext®?” WestlawNext® is an online legal research application (i.e., a web based application). When the user selects the “Yes” button, the tablet 130b creates a task command related to the task of searching for a user selected legal citation. Exemplary task properties for the exemplary task of searching for a legal citation may be the following:

Task Command A Properties

Target: WestlawNext Web Server
Broadcast Type: One Web Based Application
Command: Search a Legal Citation
User Context: User X's Account
Device Context: User X's Tablet
Additional Information: 28 U.S.C. 1915

In this instance, the tablet 130b knows the target is WestlawNext® and the broadcast type is only for one web based application 180, WestlawNext®. In addition, the command property states the command is search for a legal citation. Furthermore, the user context and device context explain to the application chat server 120 what user is requesting the task and the device from which the task command came. Lastly, the additional information includes the legal citation that will be searched by WestlawNext®. In some embodiments, a user identifier for the web based application 180 may be included in the additional information property or the user identifier may be gathered and stored during the registration process. After the task command is created, the tablet 130b transmits a task signal, via a wireless or wireline transmission channel 150, associated with the task command to the application chat server 120. The application chat server 120 receives the task signal associated with the task command and verifies that an association exists between the first access device (tablet 130b) and the web based application 180, WestlawNext®. The association is verified due to the fact that user X has registered tablet 130b and WestlawNext® to the same account. Next, the application chat server 120 analyzes the task command to determine which access device and/or web based application should execute the task. In this instance, the task command already has decided that WestlawNext® should execute the task. Therefore, the application chat server 120 generates an execution command associated with the task. The execution command properties, in this instance, include the same properties as the exemplary task command. The application chat server 120 then transmits an execution signal associated with the execution command, via the wireless or wireline transmission channel 150, to a web server 165 for the web based application 180, WestlawNext®. At this point two exemplary scenarios may occur. In the first scenario, user X may already be logged into an instance of WestlawNext®. In that exemplary scenario, the execution signal associated with the execution command is received by the web server 165. The web server 165 finally executes the execution command by reading the command and additional information properties. The web server 165 decides the best course of action for executing the task. For example, a pop-up message may occur within the web based application 180 that informs the user that a task has been received and asks whether the user would like to view the document. If the user selects “Yes” to view the document, a legal document associated with searched the legal citation is displayed to user X within the web based application 180, WestlawNext®. If the user selects “No” to view the document, the message remains within the web based application 180 to handle as necessary. In other words, once the message is received by the web based application 180, the command queue 105 no longer keeps track of whether the message was viewed. The command queue 105 and application chat server 120 only know that the message was delivered. In the second scenario, user X is not logged into an instance of WestlawNext®. In this exemplary scenario, the web server 165 transmits, via the wireless or wireline transmission channel 150, a failure signal associated with a notification of a failure to perform the execution command against WestlawNext® at the current time. The application chat server 120 receives this failure signal and, in response, stores the execution command in the command queue 105 until user X has an instance of WestlawNext®. Once user X logs in and has an instance of WestlawNext®, the web server 165 transmits a message signal, via the wireless or wireline transmission channel 150, to the application chat server 120. The message signal is associated with a message of an indication that the web based application 180 can perform a stored execution command. This message essentially notifies the application chat server 120 that the web based application 180, via the web server 165, is now ready to perform the task because user X has logged into WestlawNext®. Next, the application chat server 120 re-transmits an execution signal, via the wireless or wireline transmission channel 150, associated with the stored execution command. At this point, the second scenario integrates with the first scenario with respect to the web server 165 receiving the execution signal associated with the stored execution command and executing the execution command. Again, the legal document associated with searched the legal citation is displayed to user X within the web based application 180, WestlawNext®.

In another working example, user Y wants to trade stock. User Y may be in transit and not able to access the trading web based application and/or the trading software installed on an access device. For example, user Y may be driving and hear on the radio that Company A's Chief Executive Officer (CEO) is charged with driving while intoxicated. User Y makes the following note on his smartphone 130a—“Sell Company A's stock using e*Trade.” This notation may be written or oral. For example, user Y may make access the notation software within the smartphone 130a to type a note. In another example, user Y may record an audio notation within the smartphone 130a. Either way, the first step would be to enable speech recognition software to identify any actions/verbs within the notation. Exemplary speech recognition software on a smartphone 130a may be Apple's® Siri technology. In the current example, the speech recognition software would identify the action as “sell stock.” Since the smartphone 130a cannot identify any other information, a task command and associated properties are created. The exemplary task command properties may be the following:

Task Command A Properties

Target: Unknown
Broadcast Type: One Web Based Application
Command: Sell Stock
User Context: User Y's Account
Device Context: User Y's Smartphone
Additional Information: e*Trade, Company A

In this instance, the smartphone 130a does not know the target and the broadcast type is only for one web based application 180. In addition, the command property states the command is sell stock. Furthermore, the user context and device context explain to the application chat server 120 that user Y is requesting the task and that the task command came from smartphone 130a. Lastly, the additional information includes the phrases “e*Trade” and “Company A.” After the task command is created, the smartphone 130a transmits a task signal, via a wireless or wireline transmission channel 150, associated with the task command to the application chat server 120. The application chat server 120 receives the task signal associated with the task command and verifies that an association exists between the first access device (smartphone 130a) and the web based application 180, e*Trade®. The association is verified due to the fact that user Y has registered smartphone 130a and e*Trade® to the same account. Additionally, the application chat server 120 analyzed the additional information in the task command properties to determine that e*Trade® is a web based application 180 that is capable of selling stock. The application chat server 120 generates an execution command associated with the task. The execution command properties are as follows:

Execution Command A Properties

Target: e*Trade
Broadcast Type: One Web Based Application
Command: Sell Stock
User Context: User Y's Account
Device Context: User Y's Smartphone
Additional Information: Company A

The target has now changed to e*Trade® because the application chat server 120 has determined the target. Additionally, the additional information properties now only includes Company A since e*Trade® was determined to be a web based application 180 and therefore no longer needed in the additional information. The application chat server 120 then transmits an execution signal associated with the execution command, via the wireless or wireline transmission channel 150, to a web server 165 for the web based application 180, e*Trade®.

In other embodiments, the task command properties may not specify which access device or web based application 180 can perform the task of selling stock. Therefore, there are a few options from which the application chat server 120 may choose. For example, trading web based applications and/or software for access devices may include e*Trade®, trading tools from Charles Schwaub, Reuters 3000 Xtra, Thomson ONE®, Thomson Reuters® Eikon® and the like. These examples may be for a consumer and/or a professional. In this example, the application chat server 120 may transmit an execution signal to a desktop 130c and a web based application 180 to see which one can perform the task quicker. Assuming the web based application 180 does not have a logged in instance of the user, the desktop 130c that has trading software installed may be the only solution to perform the task.

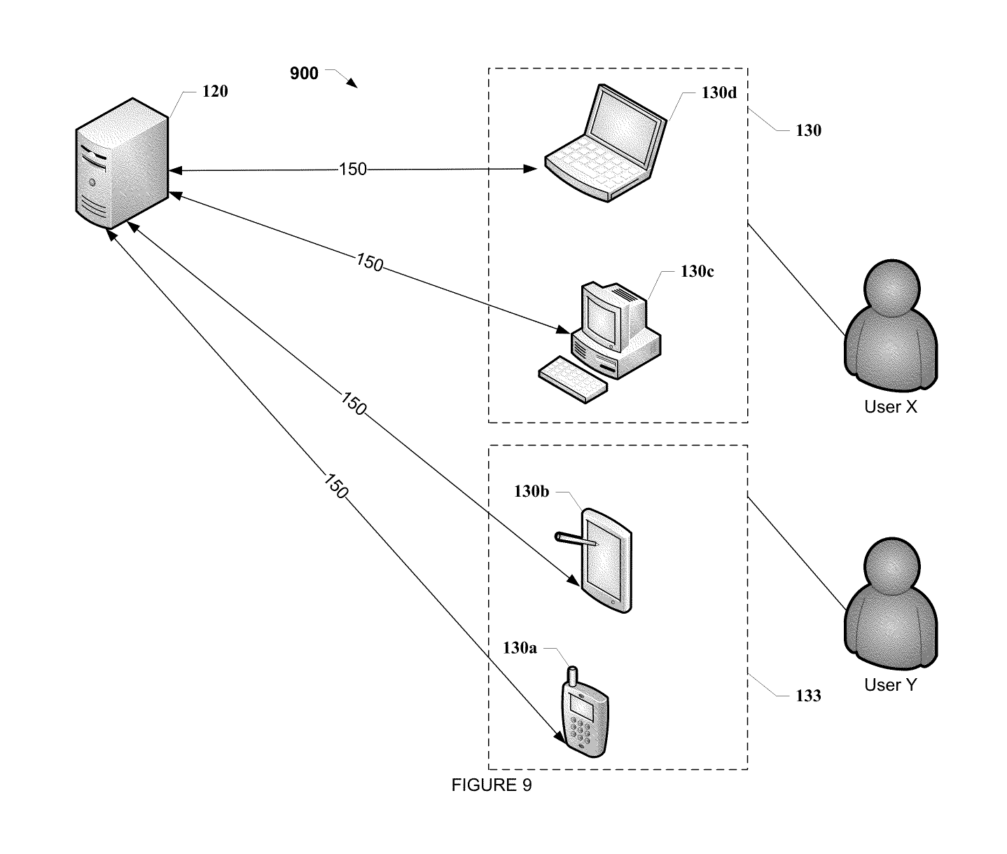

In some embodiments, an access device related to one user may order the execution of a task to be executed by another access device related to a second user. In other words, the access devices are each related to different users. This is beneficial in situations where time is of the essence and an individual does not want to necessarily transfer a file containing the information. FIG. 9 shows system 900 which may incorporate some of the capabilities, functions, methods, and interfaces of the present invention. In FIG. 9, the device application and/or web based application allows for registration of additional users. If an application allows more than one user to interact with the application, the application that registers with the application chat server 120 describes the permissions for access. By default, the registering application only allows the user of the running process to receive tasks but if the application is aware and wishes to reduce the security permissions, it can send a list of approved user identities that are enabled to interact with this application. In other instances, the registering application could also register itself as available to receive requests from any user and add filters to ensure that the registered application only receives messages that originate on trusted networks. In yet other instances, the addition of users does not occur until after the registration process. For instance, a presentation application within a desktop 130c is registered with the application chat server 120 according to the systems and methods described previously. User X's grouping of access devices 130 includes a desktop 130c and a laptop 130d associated with user X's account. User Y's grouping of access devices 133 includes a smartphone 130a and a tablet 130b associated with user Y's account. The desktop 130c registered with user X's account now wants to be able project a presentation from a tablet 130b owned by user Y. User X may go into the presentation application to add user Y to the permissions. The request to add user Y is sent to the application chat server 120, via the wireless or wireline transmission channel 150, and the application chat server 120 determines whether the user Y can be added to the presentation application permissions. The determination may use registration information from when the presentation application registered its capability and available permissions. Either way, the application decides the permission requirements when registering with the application chat server 120. For example, the application may state that permissions require a registered user. In another example, the application permissions may allow for the application to be open to any user and optionally a list of networks that the application chat server 120 filters before sending through a task.

During registration, the application chat server 120 sets up and configures the appropriate permissions and requirements. For example, desktop 130c has a device application related to presentations (herein referred to as “presentation application”) that registers with the application chat server 120. When registering, the presentation application states that its security accepts task commands from additional users besides user X and the desktop 130c. Next, the presentation application either provides a list of user identities or states a network range that accepts a task command. For example, a Transmission Control Protocol/Internet Protocol (TCP/IP) network may be used to associate and relate the location of the access device. For instance, an IP address of 112.1.2.0 would define any access device in this network, or a range of IP addresses of 112.1.2.1-112.1.2.30 would allow for thirty (30) IP addresses to be the network range. The application chat server 120 can remove and/or improve the destination of the execution command by using a filter to remove any task/execution commands emanating from a network range. For example, the task command comes from a network IP address 119.2.1.42 and the only acceptable IP address is 112.1.2.0. The application chat server 120 receives the task command but realizes that the task command did not come from an acceptable IP address. Therefore, the application chat server 120 ignores the task command and does not determine which access device should execute the task. Continuing from a previous example, the desktop 130c registered with user X's account now wants to be able project a presentation from a tablet 130b owned by user Y. If the task command did not come from an acceptable IP address, the application chat server 120 would not proceed with the task command and, therefore, would not acknowledge the tablet 130b. In addition to not acknowledging tablet 130b, the application chat server 120 would not inform the desktop 130c of the unacceptable IP address. This lack of informing the desktop 130c happens for security/discoverability reasons. For example, if error messages were sent to the tablet 130b, the tablet 130b would have knowledge of other access devices' capabilities. This knowledge may provide a security breach for some networks. In some embodiments, the task associated with the task command is indicated as a general, publicly visible task. A general/publicly visible task is a task that may be executed by a non-specific access device. By default, the indication is a true indication that the task is publicly visible. However, if the indication is set to “false,” the access device generating the task command would have to explicitly know the access device that will execute the execution command (i.e., the task) and include that specific access device information within the task command.

In order for the application chat server 120 to determine if a different user has permissions, a format for user identities should be established. For instance, the user identities could be a unique username for each application, a unique username for within the application chat server 120, a domain and username and/or an email address.

Once permissions have been established, user Y may now project his presentation from his tablet 130b to user X's desktop 130c. In some embodiments, any and/or all of the aspects of previously described systems and/or methods may be used for task transmission and receipt. For example, user Y may generate a task command based on the scenario that he wants to project his presentation residing within his tablet 130b to user X's desktop 130c that is configured to project content onto a screen. From the presentation application on the tablet 130b, the tablet 130b queries the application chat server 120 for available access devices to execute a task command. This would include all access devices registered to the same user identity as well as any other access device that has the security settings reduced to allow more than one identity or network range permissions. An exemplary task command may be the following:

Task Command A Properties

Target: User X's Desktop
Broadcast Type: One Application
Command: Open presentation1.pptx
User Context: User Y's Account
Device Context: User Y's Tablet
Additional Information: C:\Documents and Settings\
U0116180\My Documents\Miscellaneous\
presentation1.pptx

The application chat server 120 determines which device should execute the task. In this case, the task command properties, via the target property, dictate that user X's desktop 130c should execute the task. In addition, the command and additional information properties help the user X's desktop 130c to determine which file should be opened from user Y's tablet 130b. In some embodiments, the additional information would include an address to the location of the presentation. In other embodiments, the additional information may include an attachment of the presentation. A copy is made of the presentation and attached into the task command which is ultimately passed along to the destination access device to execute.

After the first task is executed on user X's desktop 130c, user Y may control the presentation from the tablet 130b by sending additional tasks to through the application chat server 120 to user X's desktop 130c. For example, after the presentation is opened, user Y may want to move to the next slide in the presentation. A new task command would be generated with the new command property: move to next slide in presentation1.pptx. If in the scenario the tablet 130b sent a copy of the whole presentation, then the desktop 130c may be in control of the functions of the presentation.

In cases where the application is a web based application 180, a user would be typically logged in on a website associated with the web based application 180. The application chat server 120 would send through the user context property to the web server 165. Consequently, the web based application 180 would then be able to act upon the user context property. In some instances, the web based application 180 may run a global user identity. A global user identity has access to resources on a wider scope than a specific user. The global user identity is a privileged account and may be used in instances where the web based application 180 is trusted to understand the task command and act appropriately. A more trusted instance is where the web based application 180 takes responsibility to authenticate a user before executing any task.

In other embodiments, the application chat server 120 may not be capable of determining a specific task capability but instead may determine that the access device is available to attempt a given task. For example, the user may need to download a mobile application on a tablet 130b. The mobile application may then determine that the tablet 130b is not capable of doing a specific task but instead is open to trying to execute a task to see if it works. If the task works, then the mobile application chat server 120 may store the information regarding the capability for that tablet 130b for further tasks. Again, the tablet 130b transmits a signal, via the wireless or wireline transmission channel 150, that is associated with at least one statement of task capability and device information for tablet 130b.

The embodiments described above and in the claims are intended only to illustrate and teach one or more ways of practicing or implementing the present invention, not to restrict its breadth or scope. For example, FIG. 1 shows browser 1383 and display 1381 as having the ability to display simultaneously; however, in operation, some embodiments may present them at separate times. The actual scope of the invention, which embraces all ways of practicing or implementing the teachings of the invention, is defined by the claims and their equivalents.

1. A method comprising:
a. registering, via an application chat server, a first access device and a second access device to an account;
b. receiving, via the application chat server, a first statement of task capability and a second statement of task capability associated with the first access device and the second access device, respectively;
c. analyzing, based upon one or more of the first and second statements of task capability, a task command to determine that the second access device is capable of executing at least one task;
d. generating, in response to the analyzing step, an execution command, the execution command associated with the at least one task; and
e. transmitting an execution signal, the execution signal associated with the execution command.

2. The method of claim 1 wherein the registering step comprises registering, via the application chat server, the first access device and the second access device to a first account and a second account, respectively.

3. A method comprising:
a. verifying, via an application chat server, an association between a first access device and a second access device, the first access device and the second access device associated with a first statement of task capability and a second statement of task capability, respectively;
b. analyzing, based upon one or more of the first and second statements of task capability, a task command to determine that the second access device is capable of executing at least one task;
c. generating, in response to the determining, an execution command, the execution command associated with the at least one task; and
d. transmitting an execution signal, the execution signal associated with the execution command.

4. The method of claim 3 wherein the verifying step further comprises verifying an association between a web based application and one or more of the first access device and the second access device, the web based application associated with a web based statement of task capability.

5. The method of claim 4 wherein the analyzing step comprises analyzing, based upon the web based statement of task capability, a task command to determine that the web based application is capable of executing at least one task.

6. The method of claim 5 further comprising:
a. receiving a notification, the notification associated with a failure to perform the execution command against the web based application at a given time;
b. storing, in response to receiving the notification, the execution command in the application chat server;
c. receiving a message from the web based application, the message associated with an indication that the web based application can perform a stored execution command; and
d. re-transmitting, in response to receiving the message, the execution signal, the execution signal associated with the stored execution command.

7. The method of claim 5 wherein the task command comprises a set of properties, the set of properties include one or more of a target property, a broadcast type property, a command property, a user context property, a device context property and an additional information property.

8. The method of claim 7 wherein the first access device is a smartphone, the web based application is a trading application and the at least one task is trading stock.

9. The method of claim 7 wherein the first access device is a smartphone, the web based application is an online legal research application and the at least one task is searching a legal citation.

10. An application chat server comprising:
a. a processor;
b. a memory coupled to the processor;
c. an application chat module stored in the memory for execution by the processor, the application chat module configured to:
i. register two or more access devices to an account associated with the application chat server;
ii. receive, via the application chat server, a first statement of task capability and a second statement of task capability associated with a first access device and a second access device, respectively;
iii. analyze, based upon one or more of the first and second statements of task capability, a task command to determine that the second access device is capable of executing at least one task;
iv. generate, responsive to a determination that the first access device executes the at least one task, an execution command, the execution command associated with the at least one task; and
v. transmit an execution signal, the execution signal associated with the execution command.

11. The system of claim 10 wherein the application chat module is further configured to register the first access device and the second access device to a first account and a second account, respectively.

12. An application chat server comprising:
a. a processor;
b. a memory coupled to the processor;
c. an application chat module stored in the memory for execution by the processor, the application chat module configured to:
i. verify, via an application chat server, an association between a first access device and a second access device, the first access device and the second access device associated with a first statement of task capability and a second statement of task capability, respectively;
ii. analyze, based upon one or more of the first and second statements of task capability, a task command to determine that the second access device is capable of executing at least one task;
iii. generate, responsive to a determination that the first access device executes the at least one task, an execution command, the execution command associated with the at least one task; and
iv. transmit an execution signal, the execution signal associated with the execution command.

13. The system of claim 12 wherein the application chat module is further configured to verify an association between a web based application and one or more of the first access device and the second access device, the web based application associated with a web based statement of task capability.

14. The system of claim 13 wherein the application chat module is further configured to analyze, based upon the web based statement of task capability, the task command to determine that the web based application is capable of executing the at least one task.

15. The system of claim 14 wherein the application chat module is further configured to:
a. receive a notification, the notification associated with a failure to perform the execution command against the web based application at a given time;
b. store, responsive to a receipt of the notification, the execution command in the application chat server;
c. receive a message from the web based application, the message associated with an indication that the web based application can perform a stored execution command; and
d. re-transmit, in response to receiving the message, the execution signal, the execution signal associated with the stored execution command.

16. The system of claim 14 wherein the task command comprises a set of properties, the set of properties include one or more of a target property, a broadcast type property, a command property, a user context property, a device context property and an additional information property.

17. The system of claim 16 wherein the first access device is a smartphone, the web based application is a trading application and the at least one task is trading stock.

18. The system of claim 16 wherein the first access device is a smartphone, the web based application is an online legal research application and the at least one task is an instance of searching a legal citation.
